(19) United States
(12) Patent Application Publication
(10) Pub. No.: US 2004/0201129 A1
(43) Pub. Date: Oct. 14, 2004

(54) Solution casting method for producing film

(75) Inventor: Kazuhide Kanemura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/809,544

(22) Filed: Mar. 26, 2004

(30) Foreign Application Priority Data
Mar. 27, 2003 (JP) 2003-087841

(51) Int. Cl. B29C 39/14; B29C 39/36

(52) U.S. Cl. 264/216; 264/300; 264/217; 264/232

(57) ABSTRACT

A cope containing TAC is cast from a casting die onto a belt such that a film after the drying may have a thickness at 40 μm. A solvent of the dope solution on the belt evaporates, and thus a gel-like film may be formed. The peeling force of the gel-like film becomes to the maximum when the weight percentage of the remaining solvent in the gel-like film is 25 wt. %. In order to reduce the generation of mura or unevenness of the thickness, the gel-like film is peeled from a belt with a support of a peeling roller, when the weight percentage of the remaining solvent is at most 20 wt. %. The peeled gel-like film is dried in a tenter dryer and a casting chamber to be a film. After cooled in a cooling chamber, the film is wound by a winding device.

### BACKGROUND OF THE INVENTION

1. Field of the Invention

The present invention relates to a solution casting method for producing a film which is used as a protective film for a polarizing filter, a polarizing filter, and a liquid crystal display.

2. Description Related to the Prior Art

In a solution casting method for producing a film, polymeric materials (or polymers) are dissolved to a solvent to prepare a solution or a dispersion (hereinafter a dope solution), and the dope solution is cast from a casting die on a substrate to form a gel-like film. Then the gel-like film is peeled from the substrate, and dried so as to become a film. The film produced in this method is more excellent in optical isotropy and uniformity of thickness and has less foreign particles than that obtained in melt extrusion method. Further, the film, in which cellulose ester (especially cellulose acetate) is used as the polymer, is quite excellent in optical properties. Accordingly, the film is used for optoelectronics, such as the protective film for a polarizing filter, a retardation film, a transparent conductive film and the like.

When a cellulose acetate film is produced, it is necessary that the thickness thereof is uniform. A Japanese Patent Laid-Open Publication No. 2002-28943 (Page 2-3) teaches that, in order to obtain the cellulose acetate film having the uniform thickness, a film tension for peeling from the substrate is determined to the range of 30-350 N/m as conditions for peeling.

Recently, however, it is required that optical isotropy and uniform thickness of the film for optoelectronics are extremely highly controlled. Accordingly, when only the conditions of the tension of peeling are satisfied, then the adequate film often cannot be obtained. Especially, when the gel-like film is peeled from the substrate, then unevenness in thickness (hereinafter step-like unevenness) are in minute and sharply formed as unevenness or mura on the film. Even the small step-like unevenness has an influence on the properties of the produced film. Accordingly it is necessary to reduce the generation of the step-like unevenness.

The generation of the step-like unevenness cannot be reduced only by determining and controlling the tension of peeling. When the peeling force for peeling the gel-like film from the substrate is high, a peeling position fluctuates up- and downward on the substrate, which causes the generation of the step-like unevenness.

### SUMMARY OF THE INVENTION

An object of the present invention is to provide a solution casting method for producing a polymer film which is adequately used for optoelectronics such as a protective film for a polarizing filter, the polarizing filter, and a liquid crystal display.

Another object of the present invention is to provide a solution casting method for producing a polymer film, in which the generation of the step-like unevenness is reduced so as to produce the film excellent in thickness unevenness and plainness.

In order to achieve the objects and the other objects, in a solution casting method for producing a polymer film, a dope solution containing a polymer and a solution is cast from a die onto a substrate to form a gel-like film. a gel-like film formed of a dope solution containing a polymer and a solvent is drawn in the tangential direction of the substrate to peel the gel-like film from the substrate at a peeling speed of at least 10 m/min. A movement range in which a peeling position moves on the substrate is regulated to less than 20 mm. Then the peeled gel-like film is dried so as to obtain the polymer film.

In a preferable embodiment of the present invention, the moving direction of the peeling position changes at least four times in one second along a transporting direction of the substrate.

Preferably, a peeling roller used for peeling the gel-like film is disposed downstream from the film peeling position to support the peeled gel-like film. A distance from the film peeling position to a contact position at which the gel-like film contacts to the peeling roller is in the range of 0.1 mm to 100 mm. It is preferable to adjust the temperature of the substrate in the range of 10° C. to 40° C.

One of the causes of the generation of the step-like unevenness is the large peeling force to the gel-like film. In the present invention, a drying standard is determined to a weight of the polymer film produced by completion of drying the gel-like film. Accordingly, a weight percentage of a remaining solvent in the gel-like film to a drying standard is regulated before the peeling to the predetermined value for reducing the generation of the step-like unevenness. The optimization of the conditions for drying is necessary for the regulation.

A criterion is determined as the weight percentage of the remaining solvent in the gel-like film when the peeling force of the gel-like film is the largest. It is preferable that the peeling of the gel-like film is performed when the weight percentage of the remaining solvent is in the range of 5 wt. % to (criterion−5 wt. %) or in the range of (criterion+5 wt. %) to 50 wt. %.

When the thickness of the polymer film is less than 60 μm, the weight percentage of the remaining solvent is in the range of 5 wt. % to (criterion −5 wt. %) for peeling the gel-like film from the substrate. Further, when the thickness of the polymer film is more than 60 μm, the weight percentage of the remaining solvent is in the range of (criterion+5 wt. %) to 50 wt. % for peeling the gel-like film from the substrate. In this case, it is especially preferable that the weight percentage of the remaining solvent is in the range of 35 wt. % to 45 wt. % for peeling the gel-like film.

In order to determine the film peeling position of the gel-like film from the substrate, it is important to determine drying conditions for drying the dope solution or the gel-like film on the substrate. Preferably, the peeling speed is at most 150 m/min. Further, a transporting time is determined as a time for which the gel-like film is transported on the substrate. The temperature of the gel-like film, when peeled from the substrate, has a temperature of 10° C. to 50° C. The transporting time is preferably in the range of 0.5 min to 10 min. It is preferable to feed into the casting chamber 27 the drying air having the temperature in the range of 60° C. to 140° C.

Further, in order to effectively reduce the peeling force, a release agent is added to the dope solution. In this case, even when the weight percentage of the remaining solvent is not in a region for generating the step-like unevenness, the peeling force can become small, and it is preferable to use the produced polymer film for optical product. It is preferable to use as the solvent a mixture solvent of dichloromethane and alcohol of more than 8 wt. %. It is particularly preferable to use as the alcohol at least one of methanol, ethanol and n-butanol. It is especially preferable to add acidic materials to the dope solution.

Cellulose acylate is used as the polymer. The preferable cellulose acylate is cellulose acetate, and especially cellulose triacetate.

The produced polymer film is used for a polarizing filter, as a protective film for the polarizing filter, and in a liquid crystal display.

According to the solution casting method for producing the film of the present invention, as the peeling speed for peeling the gel-like film is at least 10 m/min and the moving direction of the peeling position changes at least four times in one second along a transporting direction of the substrate, the generation of the step-like unevenness is reduced.

As the gel-like film is peeled from the substrate when the weight percentage of the remaining solvent is in the range of 5 wt. % to (the criterion−5 wt. %) or in the range of (the criterion+50 wt. %) to 50 wt. %, the peeling force for peeling the gel-like film is small, and the generation of the step-like unevenness is reduced.

In order to produce the film having the thickness of at most 60 mm, the gel-like film is peeled from the substrate when the weight percentage of the remaining solvent is in the range of 5 wt. % to (the criterion−5wt. %). In order to produce the film having the thickness of more than 60 mm, the gel-like film is peeled from the substrate when the weight percentage of the remaining solvent is in the range of (the criterion+5wt. %) to 50 wt. %, especially 35 wt. % to 45 wt. %. Accordingly, the generation of the step-like unevenness is reduced.

As the additives are added to the dope solution, the peeling force for peeling the gel-like film becomes smaller. Accordingly, the generation of the step-like unevenness is reduced.

As the solvent, the mixture solvent containing the dichloromethane and alcohol is used, and the weight ratio of the alcohol is more than 8 wt. %. Accordingly, the generation of the step-like unevenness is reduced.

The film produced in the solution casting method of the present invention is excellent in optical properties, as the generation of the step-like unevenness is reduced. Therefore the film is used in the optoelectronics product, such as a protective film for a polarizing filter, the polarizing filter, and a liquid crystal display.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a film production line for performing a solution casting method for producing a film of the present invention;

FIG. 2 is a schematic diagram illustrating a situation of a gel-like film peeled from a belt in the film production line in FIG. 1;

FIG. 3 is a graph showing an example of a relation between a time and a peeling position at which the gel-like film from the belt;

FIG. 4 is a graph showing a relation between a weight percentage of a remaining solvent in and a peeling force of the gel-like film.

### PREFERRED EMBODIMENTS OF THE INVENTION

[Solvent]

Any solvents already known can be used for preparing a dope solution used in a solution casting method of the prevent invention. It is especially preferable to use hydrocarbon halides (such as methylene chloride (dichloromethane) and the like), esters (such as methyl acetate and the like), ethers, alcohols (methanol, ethanol, n-butanol and the like), ketones (such as acetone and the like) and the like. However, the solvent is not restricted in them. Further, a mixture solvent in which several sorts of the above solvents are mixed is also used for obtaining the dope solution.

Further, in the present invention, when TAC is used as polymer which is mentioned below, it is preferable to use the mixture solvent since TAC is dissolved well to make the preparation of the dope solution more easily. In this case, the preferable main solvent of the mixture solvent is dichloromethane. The preferable sub-solvent is alcohols described above, and the especially preferable one is methanol. The weight percentage of methanol as the sub-solvent in the mixture solvent is preferably between 5 wt. % and 30 wt. %. Especially preferable weight ratio of dichloromethane and methanol is; dichloromethane:methanol=92 wt. %:8 wt. %. Note that also methyl acetate can be used as the main solvent of the mixture solvent.

[Polymer]

The polymers used in the present invention are, for example, there are cellulose esters (such as cellulose acylate), polyethylene telephthalate, polybutylene telephthalate, polyethylene-2,6-naphthalate, and the like. However, the polymer is not restricted in them. Note that the preferable polymer in the present invention is cellulose acylate, and especially cellulose triacetate (TAC) which has degree of acetylation in the range of 59.0%-62.5%. Note that as raw materials of TAC there are cotton linter and wood pulp. Single one or mixture of these two raw materials may be used for obtaining the TAC.

[Additives]

Additives already known can be added to the dope solution. As the additives, there are plasticizers (such as triphenyl phosphate (TPP), biphenyldiphenyl phosphate (BDP) and the like), UV stabilizer (including UV absorbent), matching agents (such as silicone dioxides) and the like, thickening agents, gelating agent, and the like. However, the additives are not restricted in them. Further, as the additives, there are release agents which are mentioned below. The additives may be mixed with the polymers in preparation of the dope solution, and otherwise, an inline mixing of the additives may be performed with a static mixer while the prepared dope solution is fed in a line. Note that the term of solid materials is often used as the general term of the polymer and the additives.

(Release Agents)

In the present invention, in order to decrease the peeling force for peeling the gel-like film from the substrate, it is preferable to add the release agents to the dope solution previously. As the release agents, there are glucolic acid, derivatives of glucose that have acid form, glycolic acid, lactic acid, malic acid, tartaric acid, citric acid, and salts and ester derivatives of these acidic materials (half ester form of citric acid esters). However, the release agents are not restricted in them. Further, the preferable content is from 5 ppm to 6000 ppm to the weight of the solid materials except the release agents. Note that when the content of the release agents is in order of several thousands ppm, the optical properties of the produced film is not influenced. In view of the cost, the particularly preferable content is preferably from 25 ppm to 1000 ppm. However, the present invention is not restricted in the regions. The addition of the acidic materials as the release agent to the dope solution causes the higher effects of peeling from the substrate, and therefore the higher effects of reduction of the plate-out (remaining of the polymer (TAC) on the substrate after the produced film is peeled), which is adequate to the film production.

(Acids)

When the TAC is used as the polymer in the present invention, some hydroxyl groups (—OH) are not substituted and remain, and mutual action often occurs between hydrogen of the hydrogen group and a surface of the substrate. The reason therefor is that the raw material of the TAC is cellulose made of a natural material, and therefore the TAC used in the present invention does not always have the same structure of the polymer as in the known chemical formula. Accordingly, when the acidic materials which are acids or materials having characters or properties of acid are added to the dope solution, then hydrogen on the hydroxyl group is substituted. Thus the mutual action is restrained, and the gel-like film becomes more easily peeled from the substrate. As the acidic materials used in the present invention, there are citric acid, oxalic acid, glycolic acid, and the like. Citric acid is especially preferably used. However, the acidic materials are not restricted in them. Note that the amount of the acidic material to be added is preferably in the range of 5 ppm to 10000 ppm (0.000005 pts.wt. to 0.01 pts.wt) when the content of the polymer (TAC) is determined to 100 pts.wt. However, the amount is not restricted in this range.

[Preparation of Dope Solution]

In order to prepare the dope solution, the solid materials (containing the polymers and the additives) are mixed with the solvent (which may be the mixture solvent), and dissolved in any well known dissolution methods. Usually, the filtration of the obtained dope solution is made so as to remove the foreign materials. In the filtration, several sorts of filtration materials already known are used, such as filter paper, filter cloth, non-woven cloth, metal mesh, sintered metal, porous plate and the like. Thus it is reduced that the foreign materials in the produced film makes defeats.

Further, the prepared dope solution is heated so as to improve the solubility of the polymers to the solvent. In order to heat the dope solution, there are a method in which the dope solution is heated with stirring in a stationary tank, and a method in which the dope solution is simultaneously heated and fed with use of several sorts of heat exchanger, such as jackets of multi-pipe type, with static mixer or the like, and the dope solution is heated while being fed. After the heating process, there may be a cooling process to cool the dope solution. Further, when the pressure in heating devices is increased, the dope solution can be heated above the boiling point under the atmospheric pressure. In performing these processes, micro undissolved particles can be entirely dissolved. Thus the load of the filtration is decreased, and the generation of the defeats caused by the foreign particles in the film is reduced.

In the present invention, the weight percentage (concentration) of the solid material in the dope solution is preferably in the range of 10 to 30 wt. %, particularly preferably 19 to 20 wt. %. However, the weight percent is not restricted in this range. When the weight percent is less than 10 wt. %, it is too low, and therefore the time until the weight of the solvent remaining in the gel-like film becomes in the adequate level is long. In view of cost, there are some problems for production. When the weight percent is more than 30 wt. %, the viscosity of the dope solution becomes too high. Accordingly, the leveling effect of a bead formed of the dope solution cast toward the substrate becomes smaller, and the film hardly becomes flat. Thus it becomes harder to produce the film whose thickness is uniform.

[Solution Casting Method]

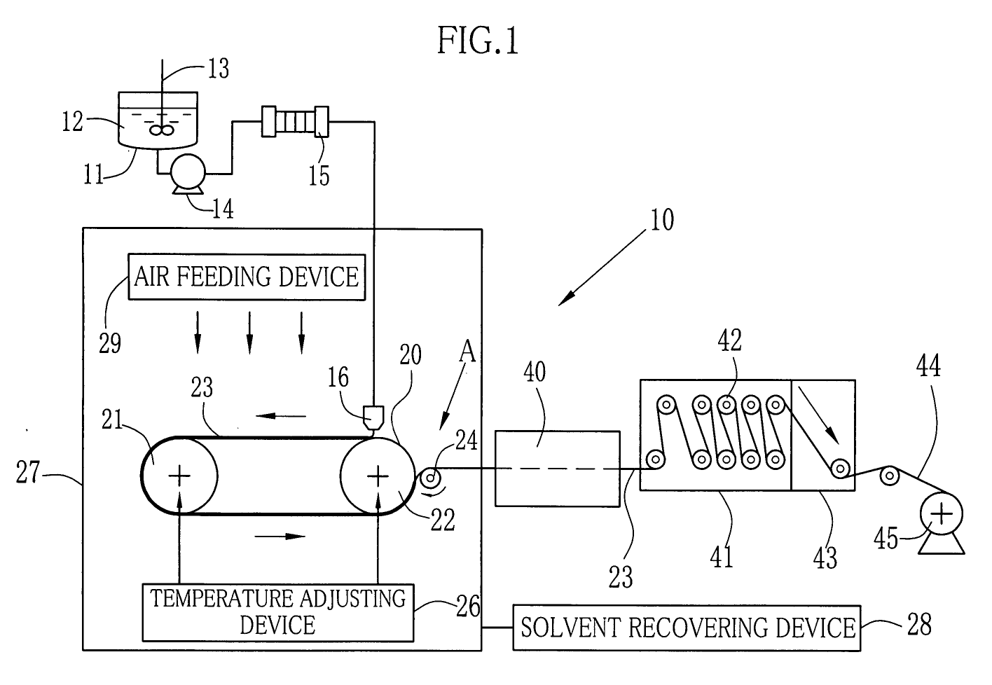

In FIG. 1, a film production line 10 has a mixing tank 11 which contains a dope solution 12 prepared in the above explained method. The dope solution 12 is stirred with a stirrer 13 such that the concentration of the every components may be uniform in the solution. The dope solution 12 is fed with a pump 14 to a filtration device 15, in which the impurities are removed.

A casting die 16 is disposed above a belt 20 as the substrate, and casts the dope solution 12 at a constant flow rate onto the belt 20 to form a gel-like film 23. The belt 20 is endlessly fed in accordance with rotation of rollers 21, 22 driven by a rotation driver (not shown). When the weight percentage of the remaining solvent in the gel-like film 23 becomes a predetermined value, the gel-like film 23 has a self-supporting property, and is peeled from the belt 20 with a roller 24 with rotating in an arrowed direction D2. Note that a temperature controlling device 26 adjust the temperature of the casting rollers 21, 22 so as to control the temperature of the belt 20 contacting to the casting rollers 21, 22.

An air feeding device 29 feeds a drying air toward the gel-like film 23 on the belt 20 so as to regulate the evaporation speed of the solvent contained in the gel-like film 23. The atmosphere in the casting chamber 27 is aspirated in a solvent recovering device 28. The solvent recovering device 28 recovers for the recycle the solvent contained in the atmosphere, which is a merit in the point of not only the cost, but also the circumstance protection since the amount of the solvent discharged in the air is reduced.

In order to peel the gel-like film 23 from the belt 20 at the predetermined weight percentage of the remaining solvent in the gel-like film 23, it is preferable to regulate the temperature of the belt 20, the film production speed, the time for the transport of the gel-like film 23 on the belt 20, and the temperature of a drying air. The temperature of the drying air blown from an air feeding device (not shown) is preferably in the range of 60° C. to 140° C. When the temperature is less than 60° C., the time to dry the gel-like film 23 is long, which is a disadvantage point in view of the cost. Further, when the temperature is more than 140° C., the solvent evaporates from the dope solution 12 or the gel-like film 23 too fast, which causes the denaturation or deformation of the gel-like film 23.

The casting die 16, the belt 20, the casting rollers 21, 22 and the like are preferably provided in a casting chamber 27. In the casting chamber 27, the solvent vapor generated from the dope solution 12 or the gel-like film 23 is recovered for recycling, which is an advantage point in view of the cost. Further, as the solvent is recovered, the amount of the solvent discharged in the air is reduced, which is preferable in view of the circumstance protection. Note that in order to dry the gel-like film 23 in the casting chamber 27, there are furthermore several drying methods which are well known. In this embodiment, the air feeding device 29 is used for feeding the drying air into the casting chamber 27 such that the temperature of the drying air may be regulated to the predetermined one in the range of 60° C. to 140° C.

Preferably, the peeling speed is in the range of 10 m/min to 150 m/min. when the film production speed is less than 10 m/min, then the cost for production hardly becomes enough low. When the peeling speed is more than 150 m/min, the dope solution is often unstably cast, and therefore, the gel-like film 23 hardly has the uniform weight percentage of the solvent. The transporting time is preferably in the range of 0.5 min to 10 min. When the transporting time is less than 0.5 min, then the drying on the belt 20 may not be made enough such that the weight percentage of the remaining solvent may be adequate. When the transporting time is more than 10 minutes, the denaturation or the deformation of the gel-like film 23 may occur. Note that the gel-like film 23, when peeled from the belt 20 in a peeling section A, preferably has a temperature in the range of 10° C. to 50° C., and particularly preferably in the range of 20° C. to 50° C. When the temperature is less than 10° C., the gel-like film 23 becomes too hard, which often damages the gel-like film 23 at the peeling thereof. Further, when the temperature is more than 50° C., the solvent rapidly evaporates from the gel-like film 23, which often damages the gel-like film 23 at the peeling thereof. Note that the atmosphere in the casting chamber 27 is aspirated in a solvent recovering device 28, and the solvent recovering device 28 recovers the solvent contained in the atmosphere.

In this embodiment, as the temperature of the belt 20, the film production speed, and the drying time on the belt are controlled, and as the temperature of the gel-like film 23 in the peeling section A is regulated, the generation of step-like unevenness is reduced. Note that the temperature of the belt 20, the film production speed, the drying time on the belt 20, and the temperature of the gel-like film 23 in the peeling section A are not restricted in the above description.

The gel-like film 23 peeled from the belt 20 is transported to a tenter dryer 40, and side edge portions of the gel-like film 23 are cripped by tenter-crips (not shown). In the tenter dryer 40, the gel-like film 23 is transported in accordance with the move of the grips and dried simultaneously. The gel-like film 23 is tensed, and thus the unevenness formed by peeling disappears. Therefore it is preferable in the present invention to use the tenter dryer 40. Preferably, in the tenter dryer 40, the drying of the gel-like film 23 is made at the temperature in the range of 80° C. to 140° C. for 0.1-3 minutes. However, the conditions for the drying in the tenter dryer 40 are not restricted in them. After the tenter dryer 40, the gel-like film 23 is transported to a casting chamber 41, in which the gel-like film 23 is transported with wrapping around plural rollers 42. Thus the gel-like film 23 is dried to become the film 44. It is preferable that the temperature in the drying chamber 41 is adjusted in the range of 80 to 145° C. and the time for drying the gel-like film 23 in the casting chamber 41 is from 5 min to 80 min. Then the film 44 is transported to a cooling chamber 43 and cooled down. Thereby it is preferable that the temperature of the film 44 may be the same as the room temperature in the cooling chamber 43. Thereafter, the film 44 is wound by a winding device 45. Note that the cooling process may be removed.

Note that it is preferable to use the peeling roller 24 for peeling the gel-like film 23 from the belt 20, since the peeled gel-like film 23 is stably transported.

Note that each of the peeling speed, the transporting time, and the temperatures of the belt 20, the air fed from the temperature feeding device 29, and the gel-like film 23 is not restricted in the above range.

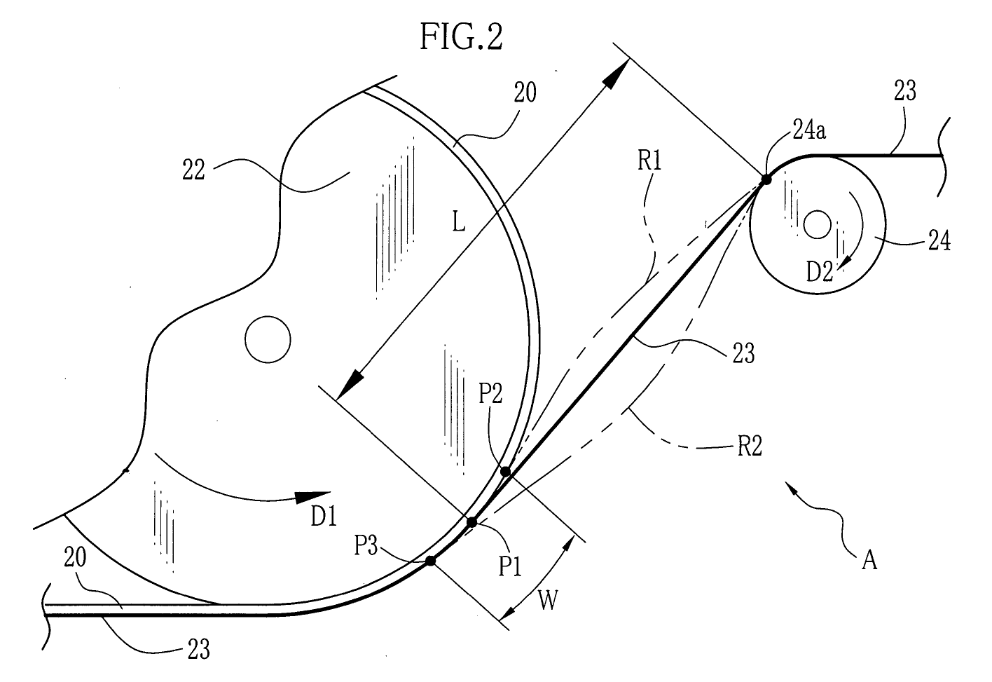

In FIG. 2, when the casting roller 22 rotates in an arrowed direction, the belt 20 is fed. On the belt 20 the gel-like film 23 is formed. When the gel-like film 23 is peeled off from the belt, both side edges of the gel-like film 23 leaves the belt 20 at a film peeling position P.

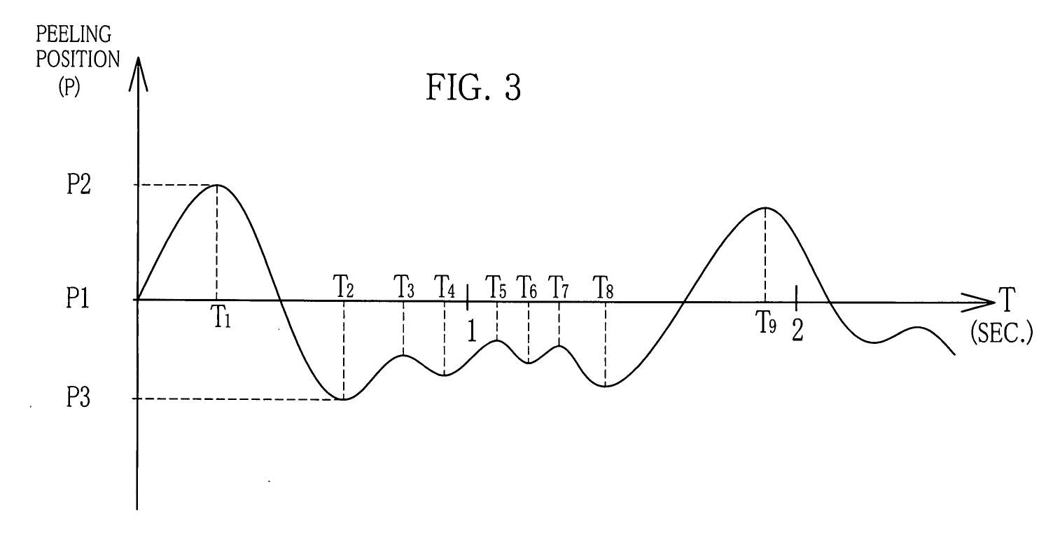

Principally, a peeling position P (see, FIG. 3) depends on positions of the belt 20 on the roller 22 and the peeling roller 24. That is, the principal peeling position P is, as shown in FIG. 2, a position (a standard peeling position P1) at which an internal common tangent between the belt 20 and the peeling roller 24 contacts to the belt 20. However, actually, the film peeling position P moves in accordance with a peeling speed, physical properties of the film (for example, adhesive strength, a thickness and the like), a material and a surface shape of the belt 20, and the like. In the film production, the peeling position P usually reciprocates at least twice. A contact point 24a is determined as a contact point of internal common tangent between the belt 20 and the peel roller 24, and a distance L is determined as the length of the internal common tangent between the contact position 24a and the standard peeling position P1 of the film peeling position P. In the present invention, the length L is preferably 0.1≦L(mm)≦100, and especially preferably 1≦L(mm)≦30. However, the length L is not restricted in these ranges. Further, the material of the belt is preferably SUS316, SUS304 and the like. However, the material is not restricted in them. Note that while the film production is not made, the film peeling position P is positioned to the standard peeling position P1 in this figure.

When the gel-like film 23 starts being peeled, the film peeling position P reciprocates on the belt 20. In the present invention, a movement range W of the film peeling position P is regulated so as to reduce the generation of the step-like unevenness in the gel-like film 23 peeled at the film peeling position P. Thererfore, the film 40 has an almost uniform thickness while the film 40 is obtained by tensing the gel-like film 23 in the tenter dryer 40 and drying in the drying chamber 41 (see, FIG. 1).

In order to make the productivity higher, it is preferable to peel the gel-like film 23 at the high peeling speed. Usually, the peeling speed of the gel-like film 23 is set to at least 10 m/min. In the high speed peeling, the moving direction of the film peeling position P changes along a transporting direction of the belt 20 many times in one second, and the movement range W of the film peeling position P becomes longer. When the peeling position P shifts too much, it is hard to produce the film having the perfectly uniform thickness. Accordingly, in the present invention, when the moving direction of the film peeling position P changes along the transporting direction of the belt 20 at least four times in one second, the movement range W of the film peeling position P is regulated to at most 20 mm. Thus, the produced film 44 can be used for the several sorts of products. Further, in order to further enlarge the productivity, the preferable peeling speed is at least 20 m/min.

Note that FIG. 3 shows the shift of the film peeling position P that is recorded with a video camera. The change of the film peeling position P to a time is illustrated as a random wave. At the extreme values of the curving line (for example, T=T1, T2, T3 and the like, then the moving direction of the film peeling position P changes along the transporting direction of the belt 20. When the film peeling position P at starting the observation is set to the origin (or standard peeling position) P1, the moving direction of the film peeling position P changes four times at T1-T4 in the first one second (T=0 to 1) in the observation, and five times at T5-T9 in the next one second (T=1 to 2). The movement range W is the difference from the maximum to the minimum of the peeling position, and illustrated as a length of arc in FIG. 2. For example, in the first one second, the movement range W is the difference, P2(T1)−P3(T2). Note that when the moving direction of the film peeling position P changes twice in one second, the movement of the film peeling position P is regarded as the reciprocating movement of 1 Hz. Accordingly, when the moving direction of the film peeling position P changes four times in T=0 to 1, the movement of the film peeling position P is regarded as the reciprocating movement of 2 Hz.

In the first on second, the movement range W is the length of arc between the most downstream position P2 and the most upstream position P3 of the film peeling position P. The gel-like film 23 peeled at the most downstream position P2 is transported on a rout R1 illustrated with double-dashed line, and the gel-like film 23 peeled at the most upstream position P3 is transported on a rout R2 illustrated with double-dashed line. In these cases, although having distortion between the casting roller 22 and the peel roller 24, the gel-like film 23 is recovered since having flexibility. Note that the routs PA1, PA2 are shown with extremely exaggeration for easy understanding.

By the way, when the film peeling position P reciprocating moves at less than 2 Hz, namely, when the moving direction of the film peeling position P changes along the transporting direction of the belt 20 less than 4 times in one second, then the film surface of the film 44 has gentle inclinations. In this case, as the mura or unevenness of the thickness in a unit length in the lengthwise direction of the film 44 does not vary so much, the produced film can be used as a film product. However, as the peeling speed must be extremely low, the productivity becomes lower.

The inventor made a following experiment of the film production. In a known film production line, the dope solution is cast on the belt. Then, after dried, the gel-like film is peeled from the belt when the weight percentage of the remaining solvent in the gel-like film is 25 wt. %. In this experiment, conditions for casting and drying are determined such that the produced film may have the thickness of 40 μm. The film peeling position P is observed with a video camera. In the observation, the film peeling position P always moves. Further, after the produced film is obtained from 1 batch of the dope solution, the step-like unevenness of the produced film is observed, and the step-like unevenness reduces the uniformity of the thickness. Therefore, the produced film cannot be used as the film product.

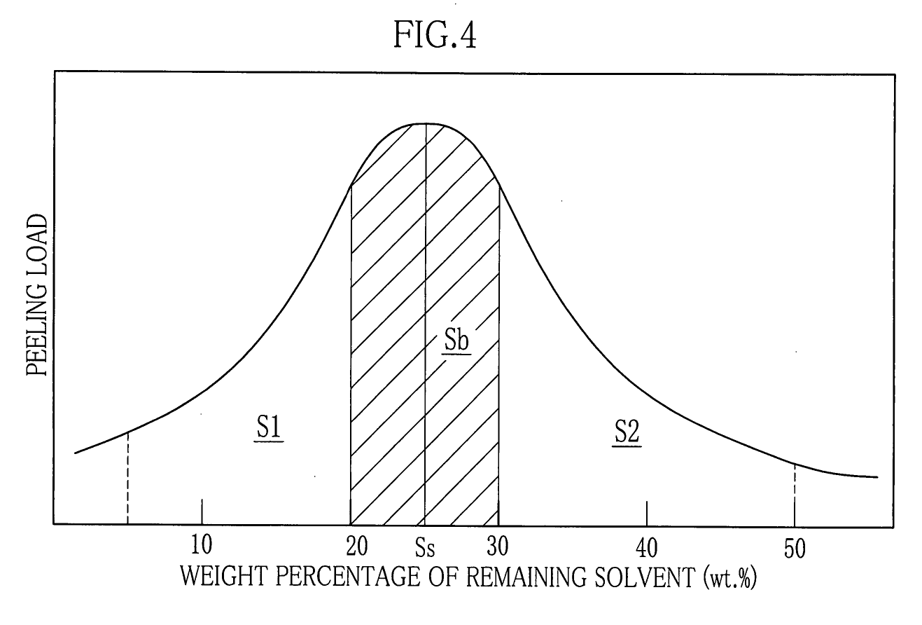

In this experiment, the inventor found that when the peeling force is large the film peeling position P reciprocate too much. As shown in FIG. 4, the peeling force depends on the weight percentage of the remaining solvent in the gel-like film. In this embodiment, the regulation of the weight percentage of the remaining solvent in the gel-like film 23 is made in the drying process on the belt 20 conveying the gel-like film 23. Thus the peeling force becomes smaller, and the effect of the present invention is obtained.

Note that the graph of FIG. 4 can be obtained in a following experiment:

19 pts.wt of Cellulose Triacetate (TAC) is dissolved into 81 pts. wt of a mixture solvent of dichloromethane and methanol (dichloromethane:methanol=92:8 in weight), such that the dope solution is obtained. Then a predetermined volume of the dope solution is cast from the casting die on a substrate. Thereafter, part of the solvent is evaporated in a known method such that the weight percentage of the remaining solvents in the gel-like film may be a predetermined one. When the weight percentage is the predetermined one, the gel-like film is peeled from the substrate, and thereby the peeling force of the gel-like film is measured in a well-known method for example with a load cell or a spring balance). The result of the measurement is illustrated in FIG. 4. At first, a dried standard is determined as a weight of the film whose drying is complete, and then the value of the dried standard is determined to 100 wt. %. And a horizontal axis of the graph represents a ratio of the weight percentage of the remaining solvent in the peeled gel-like material to the dried standard. An ordinate axis represents the peeling force for peeling the gel-like film in a relative value. Note that although the unit of the peeling force is gw/cm, the relative value of the peeling force is represented for explanation in FIG. 4. Further, this figure teaches that the peeling force is the largest when the weight percentage of the remaining solvent in the gel-like film 23 is 25 wt. %.

A criterion Ss of the weight percentage of the remaining solvent in the gel-like film 23 is determined as that one when the peeling force is at the maximum. In FIG. 4, the criterion Ss is 25 wt. % to a dried weight (hereinafter dried standard) of the dried film. However, the criterion depends on sorts of polymers and additives, and the amount of addition thereof. Further, when TAC is used as the polymer, the criterion varies depending on the degree of acetylation. Accordingly, the criterion Ss is not restricted. However, it is preferable in the present invention that the criterion Ss is in the range of 15 wt. % to 35 wt. %.

When the weight percentage of the remaining solvent in the gel-like film 23 is at or near the criterion Ss, the load of peeling the gel-like film is large, and therefore the step-like unevenness is often formed. For example, it is supposed that the gel-like film is peeled when the weight percentage of the remaining solvent is in an unpeelable range Sb between (Ss−5) wt. % and (Ss+5) wt. %, namely, between 20 wt. % and 30 wt. %. In this case, the step-like unevenness is easily formed. Accordingly, it is preferable in the present invention that the weight percentage of remaining solvent is in a peelable range S1 of 5 wt. % to (Ss−5) wt. %, or in a peelable range S2 of (Ss+5) wt. % to 50 wt. %. When the content is less than 5 wt. %, the drying of the gel-like film is made too much. Accordingly, the flexibility is lost and the gel-like film becomes hardly peeled. When the content is more than 50 wt. %, the gel-like film contains the solvent too much, and the gel-like film 12 often does not have self-supporting property. Therefore the gel-like film 23 is often hardly peeled from the belt 20 (or the substrate). Note that the peelable ranges S1, S2 of the present invention are not restricted in the above description.

Further, an explanation of another embodiment of the present invention will be made. In the present invention, when the weight percentage of the remaining solvent is in the peelable ranges S1, S2, the gel-like film 23 is peeled from the belt 20. It is particularly preferable in the present invention, however, that one of the two peelable ranges S1, S2 is selected depending on the thickness of the gel-like film 23 to be peeled, which is an advantage in view of the cost and the peeling speed.

The produced film having the large thickness is called a thick film. The thickness of the thick film is not especially restricted. However, it is preferably more than 60 μm. In order to produce the thick film, the thickness of the gel-like film 23 on the belt is large, and the evaporating time of the solvent becomes longer. Accordingly, the gel-like film is peeled when the content of the solvent is in the peelable range S2. Thus the transporting time and the time for production can be shorter. In the peelable range S2, the weight percentage of the remaining solvent is larger than in the peelable range S1, but as the thickness of the gel-like film is large, the gel-like film can easily have the self-supporting property. Therefore the failing of the peeling hardly occurs. Further, as the weight percentage of the remaining solvent may be large, the gel-like film can be dried on the belt whose temperature is low, and the denaturation of the polymer is reduced. In this case, the peelable range S2 is varied depending on the combination of the polymers, the additives, and the solvents, and substantially not restricted. However, the peelable range S2 is preferably at least (Ss+5) wt. % and at most 50 wt. %, and concretely at least 35 wt. % and at most 45 wt. %.

The film having a thickness less than 60 μm is called a thin film. In the production process of the thin film, the gel-like film on the belt has the small thickness. Accordingly, when the large amount of solvent is contained, the gel-like film 23 does often not have the enough self-supporting properties. Accordingly, it is preferable in the present invention that the gel-like film is peeled when the content of the solvent in the gel-like film is in the peelable range S1. In this case, it is necessary to dry the gel-like film 23 such that the weight percentage of the remaining solvent in the gel-like film 23 may be small. However, as the thickness of the gel-like film 23 is small, the drying is smoothly made even under loose conditions. The peelable range S1 in this case is varied depending on the combination of the polymers and the like, and substantially not restricted. However, the peelable range S1 is preferably at least 5 wt. % and at most (Ss−5 wt. %).

FIGS. 1 and 2 show a solution casting method for producing the film having a single layer. However, the embodiment of the present invention is not restricted in the figures. There are other embodiments to which the present invention can be applied. For example, a die of a multi-manifold type or a die to which a feed block is attached in the upstream side may be used as the casting die, so as to simultaneously cast the plural dope solutions. Otherwise, plural casting dies are arranged above the belt for casting plural dope solutions sequentially. Furthermore, the method for simultaneous casting and that for sequentially casting may be combined. In the above embodiments, the belt is used as the substrate. However, a rotary drum may be used instead of the belt.

[Polarizing Filter]

The film 44 produced in the solution casting method of the present invention can be used as an optical film such as a protective film for a polarizing filter. In order to produce the polarizing filter, a polarized film is formed of a polyvinylalcohol and the like, and the protective films are adhered to both surfaces of the polarized film. Further, the film 44 can be used for an optical compensation film having an optical compensation layer, and otherwise can be used for an optical function film such as antireflection film in which an antiglare layer is formed on the film. A liquid crystal display can be constructed of these products, such as the polarizing filter and the like.

[Experiments]

Now, the examination of examples of the present invention will be explained in detail, although the present invention is not restricted in it. Conditions for film production that are the same in each example are explained at first, and then the explanation of Examination 1 will follow. In Examination 1, the films of Examples 1-3 and Comparison 1 are produced and examined, among which the movement range W of the film peeling position P is changed. The conditions and results of Examination 1 are shown in Table 1. Then the explanation for Examination 2 follows. In Examination 2, the films of Examples 4-6 and Comparison 2 are produced and examined, among which the weight percentage of the remaining solvent is changed. The conditions and results of Examination 2 are shown in Table 2. Then the explanation of Examination 3 follows. In Examination 3, the films of Examples 7-10 and Comparison 3 are produced and examined, among which the amount or ratio of the peeling agents to be added to the dope solution is changed. The conditions and results of Examination 3 are shown in Table 3. Note that the same explanations or conditions as Example 1 are omitted in Examples 2-10 and Comparisons 1-3.

[Conditions for Producing Film]

As the solvent of the dope solution, the mixture solvent of dichloromethane (92 pts.wt.) and methanol (8 pts.wt.) is used. As the solid materials, the polymer is cellulose triacetate (100 pts.wt.) whose raw material is cotton linter, and the additives are triphenyl phosphate (TPP, 7 pts.wt.) and biphenyl diphenyl phosphate (BDP, 5 pts.wt.) of the plasticiser. The preparation of the dope solution is made in a known method in which dichloromethane is used as the main solvent. The concentration of the solid materials is adjusted to 19.0 wt. %. The prepared dope solution 12 is stationary set to defoam.

The film is produced in the film production line 10 illustrated in FIG. 1. The dope solution 12 is fed with the pump 14 to the filtration device 15 so as to remove impurities. Further, the casting die 16 and the belt 20 is formed from SUS316. The temperature of the drying gas is regulated to the predetermined one in the range of 60° C. to 140° C. The peeling speed is 40 m/min, and the film peeling position P reciprocates at least 2 Hz. The dope solution 12 having the temperature of 25° C. is cast on the belt 20 such that the film 44 may have the thickness of 40 μm.

The time for conveying the gel-like film 23 on the belt 20 between the casting the peeling is two minutes. The peeling of the gel-like film 23 is made with support of the peeling roller 24. The peeled gel-like film 23 is dried in the tenter dryer 40 at 120° C. for one minutes, and thereafter transported to the drying chamber 41 in which the temperature is kept to 120° C. In the drying chamber 41 the gel-like film 23 is dried for 20 minutes to form the film 44. The film 44 is cooled in the cooling chamber having the temperature of 25° C., and wound by the winding device 45.

[Discriminating Method for Generation of Step-Like Unevenness]

In order to descriminate the generation of the step-like unevenness, a light is applied to the produced film, and the transmitted light is captured by a CCD (NC300AIR, produced by CCS, Inc.). The image of the film surface of the produced film is displayed, and observed with human eyes. In this observation, the estimation of the largeness of the step-like unevenness is made. The grades of the estimations are as follows:

A: No step-like unevenness is recognized;

B: The step-like unevenness is recognized quite faintly;

C: The step-like unevenness is recognized faintly;

D: The step-like unevenness is large and recognized very clearly.

The film of estimation A and B passes the examination.

<Examination 1>

### EXAMPLE 1

In the production of the film, the peeling section A is observed with a high speed video camera (Fast CAM-NET500, produced by Photron Ltd.) through a window formed in a side wall of the casting chamber 27. Thereby the movement range W is measured. In Example 1, the movement range W is small and 4 mm. The observation of the obtained film 44 is made in the above discriminating method for the generation of the step-like unevenness. The result thereof is that no step-like unevenness is observed, and the grade of the estimation is A.

### EXAMPLES 2-3, AND COMPARISON 1

The position of the peel roller 24 is changed, and other conditions for producing the films are the same as Example 1. Each of Examples 2-3 and Comparison 1 is examined three times. The movement range W is 8 mm in Example 2 and 14 mm in Example 3. In these Examples, the step-like unevenness is small and quite faintly recognized. The estimation of the films in Examples 2 and 3 is B, and the quality of the films is good. In Comparison 1, the movement range W is 22 mm. In this case, the step-like unevenness is very clearly recognized, and the estimation of the film is D. The film cannot be used as the film product.

TABLE 1

| | Movement range W | |
|---|---|---|
| | (mm) | Estimation |
| Example 1 | 4 | A |
| Example 2 | 8 | B |
| Example 3 | 14 | B |
| Comparison 1 | 22 | D |

According to Table 1, when the movement range W is less than 5 mm, the generation of the step-like unevenness is most effectively reduced (Estimation is A). When the movement range W is less than 20 mm, the generation of the step-like unevenness is reduced such that the film can be used as the film product (Estimation is B).

<Experiment 2>

In Experiment 2, the weight percentage of the remaining solvent in the gel-like film at the peeling is regulated in each Example 4-6 and Comparison 2. In order to regulate the weight percentage of the remaining solvent, the temperature of the belt 20 and the time for conveying the gel-like film 23 on the belt 20 is changed. Note that as it is hard to directly measure the weight percentage of the remaining solvent, the atmosphere in the casting chamber 27 is sucked in the solvent recovering device 28 in which the solvent in the atmosphere is recovered. The weight percentage of the remaining solvent is estimated from the amount of the recovered solvent and the amount of the solvent used for preparing the dope solution.

### EXAMPLE 4

In Example 4, the temperature of the drying air is adjusted to 115° C., and the time for conveying on the belt is 2 minutes. Other conditions for producing the film are the same as in Example 1. The weight percentage of the remaining solvent to the drying standard is 15.2 wt. %. In observation of the produced film, no step-like unevenness is recognized, and the estimation of the film is A.

### EXAMPLES 5-6

In Example 5, the temperature of the drying air is adjusted to 110° C., and the time for conveying on the belt is 1.5 minutes. The weight percentage of the remaining solvent is 17.9 wt. Other conditions for producing the films are the same as in Example 4. In Example 6, the temperature of the drying air is adjusted to 90° C., and the time for drying on the belt is 1.5 minutes. The weight percentage of the remaining solvent is 19.5 wt. %. Other conditions for producing the film are the same as in Example 4. In observation of each film of Examples 5-6, the step-like unevenness is small and recognized quite faintly. The estimation of the films in Examples 5-6 is B, and the quality of the film is good.

### COMPARISON 2

In Comparison 2, the temperature of the drying air is adjusted to 90° C., and the time for conveying on the belt is 1.2 minutes. The weight percentage of the remaining solvent is 24.5 wt. %. Other conditions for producing the film are the same as in Example 4. The step-like unevenness is very clearly recognized, and the estimation of the film is D.

TABLE 2

| | Weight Percentage of | |
|---|---|---|
| | Remaining Solvent (mm) | Estimation |
| Example 4 | 15.2 | A |
| Example 5 | 17.9 | B |
| Example 6 | 19.5 | B |
| Comparison 2 | 24.5 | D |

Table 2 teaches that, when the weight percentage of remaining solvent is about 25 wt. % for producing the film having thickness of 40 μm, the step-like unevenness is formed and the produced film cannot be used as the film product.

<Experiment 3>

In Experiment 3, half ester form of citric acid as the release agent is added to the dope solution. Other conditions for producing the film are the same as Example 1.

### EXAMPLES 7-10 AND COMPARISON 3

In Examples 7-10 and Comparison 3, the ratios of the added release agent (half ester of citric acid) to solid material (TAC and Plasticizer) of the dope solution for preparing the dope solutions are respectively 25, 60, 500, 5, and 2 ppm. Other conditions for producing the films with the respective films are the same as in Example 1. In the films obtained in Examples 7-9, no step-like unevenness are recognized, and the estimations thereof are A. In Example 10, the step-like unevenness is recognized quite faintly, and the estimation for the film is B. In Comparison 3, the step-like unevenness is recognized faintly, and the estimation for the film is C.

TABLE 3

| | Ratio of Releasing Agent | |
|---|---|---|
| | to Solid Materials (ppm) | Estimation |
| Example 7 | 25 | A |
| Example 8 | 60 | A |
| Example 9 | 500 | A |
| Example 10 | 5 | B |
| Comparison 3 | 2 | C |

In Experiment 3, when the condition of the ratio of release agent to the solid material is in the range of 5 ppm to 6000 ppm, the step-like unevenness is not generated. As shown in FIG. 4, the ratio is preferably in the range of 25 ppm to 500 ppm. Note that the produced film can be used in a sort of the film product even when the ratio is 2 ppm. In this case the estimation was B.

<Experiment 4>

In Experiment 4, the composition ratio of the mixture solvent for the dope solution is changed. The composition ratio between dichloromethane and methanol is:

(dichloromethane):(methanol)=87 pts.wt: 13 pts.wt. Other conditions for producing the film are the same as in Comparison 2 of Experiment 2. The result of this experiment is that the weight percentage of the remaining solvent is 25 wt. %. Further, the step-like unevenness is recognized quite faintly, and therefore the grade of the estimation becomes higher to B while the unevenness is recognized very clearly (estimation D) in Comparison 2. As described above, the larger composition ratio of alcohol in the solvent for the dope solution also reduces the generation of the step-like unevenness.

Various changes and modifications are possible in the present invention and may be understood to be within the present invention.

What is claimed is:

1. A solution casting method for producing a polymer film from a dope solution containing a polymer and a solvent, comprising steps of:
casting said dope solution from a casting die on a substrate to form a gel-like film;
drawing said gel-like film in a tangential direction of said substrate to peel said gel-like film from said substrate at a peeling speed of at least 10 m/min;
regulating to less than 20 mm a movement range in which a peeling position of said gel-like film moves on said substrate; and
drying said peeled gel-like film so as to obtain said polymer film.

2. A solution casting method as claimed in claim 1, wherein the moving direction of said peeling position changes at least four times in one second along a transporting direction of said substrate.

3. A solution casting method as claimed in claim 1, wherein a peeling roller is used for peeing said gel-like film.

4. A solution casting method as claimed in claim 3, wherein a length of an internal common tangent of said peeling roller and said substrate is in the range of 0.1 mm to 100 mm.

5. A solution casting method as claimed in claim 3, wherein a temperature of said substrate is adjusted in the range of 10° C. to 40° C.

6. A solution casting method as claimed in claim 5, wherein said peeling speed is at most 150 m/min.

7. A solution casting method as claimed in claim 6, wherein a transporting time for transporting said gel-like film on said substrate is in the range of 0.5 min to 10 min.

8. A solution casting method as claimed in claim 7, wherein a temperature of said gel-like film at peeling is in the range of 10° C. to 50° C.

9. A solution casting method as claimed in claim 3, wherein when a peeling force for peeling said gel-like film is at the maximum, a weight percentage of a remaining solvent in said gel-like film to a weight of said polymer film is determined as a criterion, and while said gel-like film is peeled, said weight percentage of said remaining solvent is in the range of:
5 wt. % to (said criterion measure−5 wt. %), or (said criterion measure+5 wt. %) to 50 wt. %.

10. A solution casting method as claimed in claim 9, wherein when a thickness of said polymer film is at most 60 μm, a weight percentage of said remaining solvent at peeling said gel-like film is in the range of 5 wt. % to (criterion−5 wt. %).

11. A solution casting method as claimed in claim 9, wherein when a thickness of said polymer film is more than 60 μm, a weight percentage of said remaining solvent at peeling said gel-like film is in the range of (said criterion measure+5 wt. %) to 50 wt. %.

12. A solution casting method as claimed in claim 11, wherein when a thickness of said polymer film is more than 60 μm, said criterion is 30 wt. %, and a weight percentage of said remaining solvent at peeling said gel-like film is in the range of 35 wt. % to 45 wt. %.

13. A solution casting method as claimed in claim 9, wherein a peeling roller used for peeing said gel-like film is disposed downstream from said substrate, and a distance from said peeling position and said peeling roller is in the range of 0.1 mm to 100 mm.

14. A solution casting method as claimed in claim 9, wherein a release agent is added to said dope solution.

15. A solution casting method as claimed in claim 3, wherein said solvent is a mixture solvent containing dichloromethane and alcohol, and a weight ratio of said alcohol is more than 8 wt. %.

16. A solution casting method as claimed in claim 15, wherein at least one of methanol, ethanol, n-butanol is used as said alcohol.

17. A solution casting method as claimed in claim 15, wherein materials which are acids or materials showing characters or properties of acid in said dope solution.

18. A solution casting method as claimed in claim 3, wherein cellulose acylate is used as said polymer.

19. A solution casting method as claimed in claim 18, wherein said polymer film is used for a polarizing filter.

20. A solution casting method as claimed in claim 18, wherein said polymer film is used as a protective film for said polarizing filter.

21. A solution casting method as claimed in claim 18, wherein said polymer film is used in a liquid crystal display.
